(19) United States
(12) Patent Application Publication
(10) Pub. No.: US 2014/0174560 A1
(43) Pub. Date: Jun. 26, 2014

(54) BYPASS SEAL FOR ROTARY REGENERATIVE AIR PREHEATERS

(71) Applicant: NATHAN HASTINGS, Dallas, TX (US)

(72) Inventor: NATHAN HASTINGS, Dallas, TX (US)

(21) Appl. No.: 13/723,072

(22) Filed: Dec. 20, 2012

(51) Int. Cl. F16J 15/16; F16L 55/00

(52) U.S. Cl. CPC F16J 15/16; F16L 55/00
USPC 137/384; 29/428

(57) ABSTRACT

A rotary seal system is disclosed for an air circulating system. The rotary seal system includes a rotary shell having one or more air circulation chambers. The system includes a plurality of stationary, flexible seal bodies arranged in an angled fashion operatively coupled about opposing circumferential edges of the rotor shell to maintain separation between the one or more air circulation chambers. In one embodiment, a helical ramp disposed in at least one of the plurality of stationary, flexible seal bodies provides internal realignment of the flexible seal bodies.

### FIELD OF THE DISCLOSURE

The rotary regenerative air preheater being cylindrical in design, utilizes sealing devices, commonly referred to as bypass seals, for containing flow at both ends of the cylindrical rotor body as it rotates. The following disclosure describes an improved bypass seal design for use in rotary regenerative air preheaters.

### BACKGROUND

Referring to FIG. 1(a), a front view 103 of conventional shingled bypass seals 100, 101 (identical or selfsame seal as that of 100) is shown including cut thin slits 105, e.g., seal slit 105. Leafs of the bypass seals 100, 101 have leaf width 110, and alignment/installation holes 118. Continuing with FIG. 1(a), conventional bypass seals 100, 101, cut thin slits 105 are installed having a leading edge 120 perpendicular, i.e., 90 degrees, with respect to a contact edge of the conventional bypass seals 100, 101 to an outer diameter 130 of a rotor t-bar cylindrical body. As best illustrated in cross-sectional view 102 (FIG. 1(c)) of FIG. 1(a), conventional bypass seals 100, 101 are shingled, e.g., one seal on top of the other, and offset from one another, e.g., each of the bypass seals 100, 101 are installed offset, for example, by one or more alignment/installation hole(s) 118 to cover thin slits 105 of each bypass seal 100, 101. As illustrated in side perspective view 125 (FIG. 1(b)), bypass seals 100, 101 are bent to contact with an outer diameter of the rotor t-bar trough of cylindrical body 130.

Now turning to FIGS. 2(a) and 2(c), a front view 170 and a cross sectional view (E) 128 of conventional bypass seals 150, 151 (identical or self same seal as that of 151) are designed to be interlocked at seal portion 155, e.g., bent 155 or bent portion 155, with one another. The interlocking bypass seals 150, 151 are press formed and include tabs 152, 153, within each leaf 154. Referring to front view 170 of bypass seal 150, 151, tabs 152, 153 are parallel with each slit of the thin slits 105. Referring to front view 170, slits of bypass seals 150, 151 interlock at seal portion 155 in a shingling fashion with a preceding leafs of 150, 151 to cover a leading edge, e.g., leading edge 122, of a preceding leaf. In this conventional design, each preceding leaf covers the leading edge, e.g., leading edge 122, to primarily eliminate a catch point, e.g., a position where the leaves, for instance, move out of position, by covering the thin slits 105. Furthermore, as illustrated in FIG. 2(c), side view 175 illustrates after interlock at seal portion 155, the bypass seals 150, 151 are bent to contact with an outer diameter oft-bar trough of the rotor cylindrical body 130

As discussed above, conventional prior art seals have a major seal body which is partially slit to form the leaves. Each of the leaves may be individually bent at an angle to form a contact edge on a contact surface, e.g., t-bar surface, sealing angle, or a circumferential sealing ring, on a rotary air circulation system. During bypass seal wear-in, contact edge(s) wear of conventional seal types create abrupt edge(s), e.g., one or more catch point(s), that may prevent adequate sealing within an air chamber. In conventional systems, to partially compensate for the catch point, conventional interlocking seals decrease seal width to form the interlocking leaves, e.g., interlocking leaf(s) at seal portion 155, which reduction in width cause the leaves to be more susceptible to deformation. As a consequence, conventional interlocking leaves, e.g., interlocking leaf(s) or leaves at seal portion 155, shed flexing motion directly to a base of a bypass seal, e.g., bypass seal 150, 151, of one or more leaves, e.g., leaf 154, and by bending, creates on many occasions, one or more failing flexibility or hinge points. In addition, when a conventional bypass seal slit is positioned perpendicular to the outside diameter of a rotary air circulation system, it creates a condition that makes it difficult for the seal flexing back to its original position; thus, this situation may create a catch point.

As such, there is a need for improvements in bypass seal design that overcomes one or more issues mentioned above, e.g., improved interlocking or overlap features, as well as provide other improvements including; reduced bypass seal resistance to flexing to prevent seals staying deformed and not flexing back into the original position, improved seal geometry or installation procedures that reduce creation of catch point deformation(s), for example, when a bypass seal slit positioned perpendicular to an outside diameter of the rotor.

### SUMMARY

In one aspect, a rotary seal system is disclosed for an air circulating system including a rotor shell having one or more air circulation chambers. In one example, the system includes a plurality of stationary, flexible seal bodies arranged in an angled fashion operatively coupled about opposing circumferential edges of the rotor shell to maintain separation between the one or more air circulation chambers. In one variant, a helical ramp disposed in at least one of the plurality of stationary, flexible seal bodies to provide internal realignment of the flexible seal bodies.

In another aspect, a method is disclosed for manufacturing a sealing structure about cylindrical structure for a rotor shell. In one example, the method includes forming leafs of a bypass seal body having a length at a substantially acute angle within a range of one-quarter to three quarters from a contact area of shingles of the bypass seal body to a rotor body shell.

In yet another aspect, a method is disclosed for installing a bypass seal for a rotor shell, the method includes attaching a bypass seal to the air preheater housing which forms a trough with the t-bar on the hot and cold end of the rotor shell, the t-bar shaped trough oriented parallel to an outer shell of the rotor shell, and attaching adjacent flexible seal bodies on opposing circumferential edges of an air preheater housing so that a bypass seal top outer layer of the adjacent seal bodies contacts the t-bar shaped trough on a helical ramp having a substantially acute angle between 25 to 75 degrees, whereby the bypass seal top outer layer maintains contact with the t-bar shaped trough independent of a temperature of operation of the rotor shell.

These and other embodiments, aspects, advantages, and features of the present disclosure will be set forth in part in the description which follows, and in part will become apparent to those skilled in the art by reference to the following description of the disclosure and referenced drawings or by practice of the disclosure. The aspects, advantages, and features of the disclosure are realized and attained by means of the instrumentalities, procedures, and combinations particularly pointed out in the appended claims.

### BRIEF DESCRIPTION OF THE DRAWINGS

FIG. 1 is an illustration of a front view (FIG. 1a), a side view (FIG. 1b), a cross-sectional view (FIG. 1c) of a prior art shingled bypass seal;

FIG. 2 is an illustration of a front view (FIG. 1a), a side view (FIG. 1b), a cross-sectional view (FIG. 1c) of another prior art interlocking bypass seal;

FIG. 3 is a block diagram of a bypass seal body and its properties in accordance with the present disclosure;

FIG. 4 is an illustration of the bypass seal body of FIG. 3 including installation in a rotor shell on a hot end and a cold end of a stationary air preheater housing in accordance with the present disclosure;

FIG. 5 is an illustration of a quarter section view of the bypass seal body of FIG. 4 showing an acute angle of the bypass seal body and its contact with a vertical sidewall of a t-bar, and the trough it forms, positioned on the hot end of the stationary air preheater housing in accordance with the present disclosure;

FIG. 6 is an illustration of an exploded view of the bypass seal assembly found on FIG. 5, and the manner in which it is installed. The exploded view also depicts the inter-action between the helical ramp of the bypass seal assembly and the large particulate effluent. The multi-layered, staggered, bypass seal bodies illustrating overlap with one or more adjacent leafs, for a hot end or a cold end of the stationary air preheater housing in accordance with the present disclosure; and

FIG. 7 is an illustration of a bypass seal assembly showing both layers, the bottom inner layer (partially removed to increase visibility of a top outer layer), and the top outer layer with its formed ridges that contact the bent portion of the bottom inner layer at an acute angle, which formed ridges which function as the helical ramp to deflect effluent away from contact edge and provide internal realignment of the bypass seal to the t-bar; and

FIGS. 8 and 9 are methods illustrating respectively manufacturing or usage of the bypass seal bodies of FIGS. 1-7 in accordance with the present disclosure.

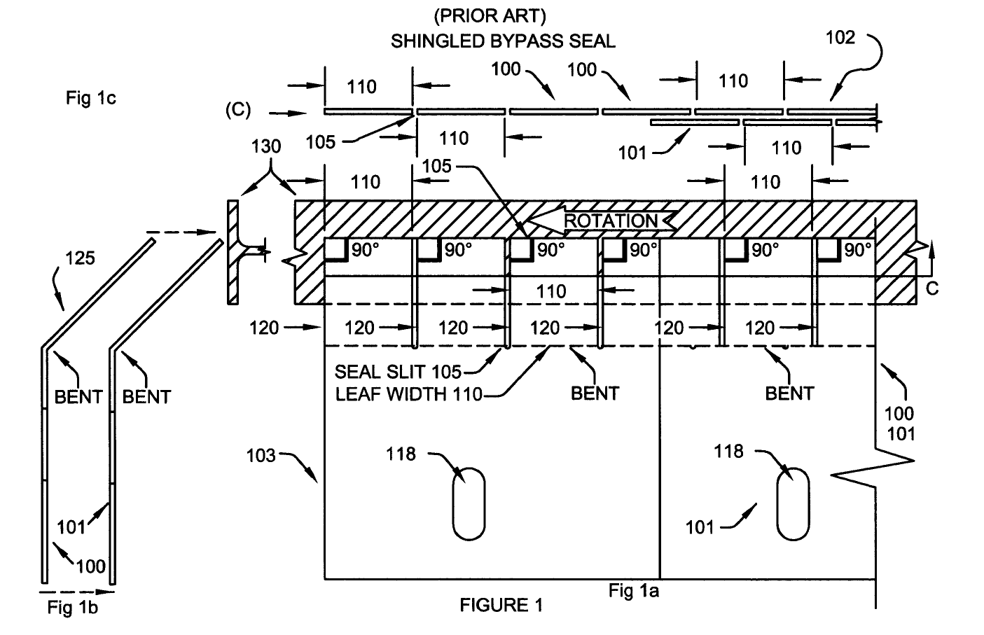

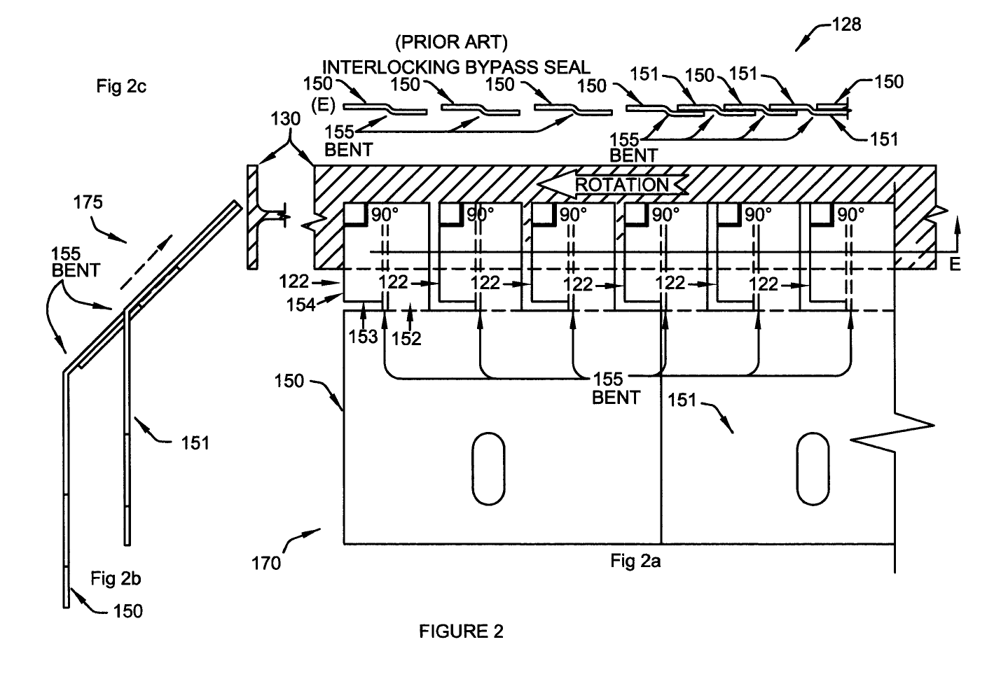

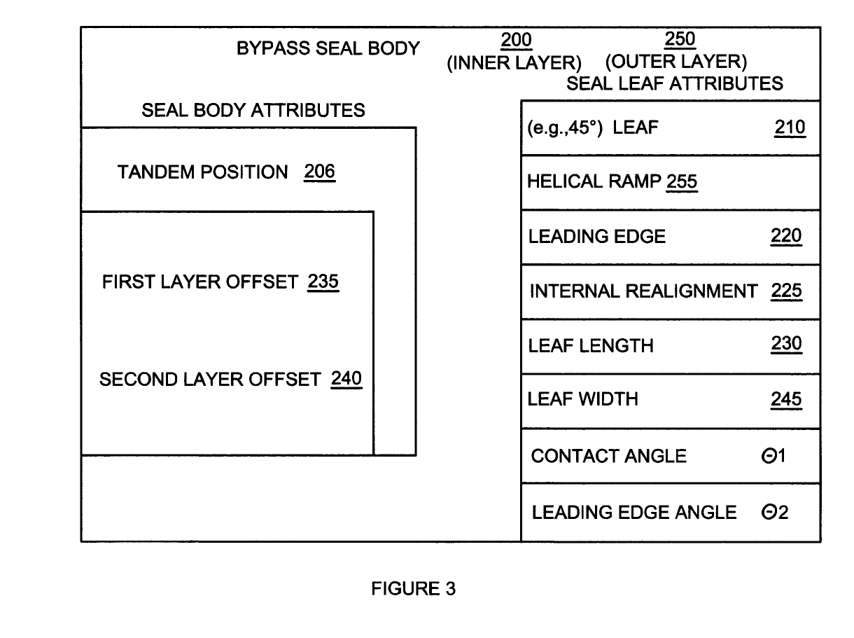

### DETAILED DESCRIPTION

The seal design of the present disclosure contains a substantially acute degree angled leaf The leaf is without a leading edge near perpendicular to the rotor outside diameter to reduce opportunity to create catch point deformation and maintain better contact between rotor and bypass seal even when effluent sources, e.g., solid, liquid, or the like, are introduced between the rotor and the bypass seal(s).

“As used herein” statements.

the term “internal alignment guide” refers to, but is not limited to, the effect of the seal leaf slits which emanate from the seal body at a substantially acute angle, e.g., 45 degree angle, before they are bent to form the contact angle thereby creating a contact edge that is downstream from the point where the leaf joins the seal body, which has the effect of drawing the seal leaf back into position when displaced by large chunks of effluent that dislodge into the bypass seal trough during operation;

the term “contact angle” refers to, but is not limited to, the angle that the leaf forms with the seal body in a plane other than that of the seal body;

the term “seal body” and/or “seal bodies” refers to, but is not limited to, the portion of the bypass seal, e.g., flexible seal bodies 200, 250, that makes up the seal mount to the air-preheater housing; and

the term “tandem position” refers to, but is not limited to, the position of the like seal placed on top of the preceding seal offset by one mounting hole or half the width of the leaf.

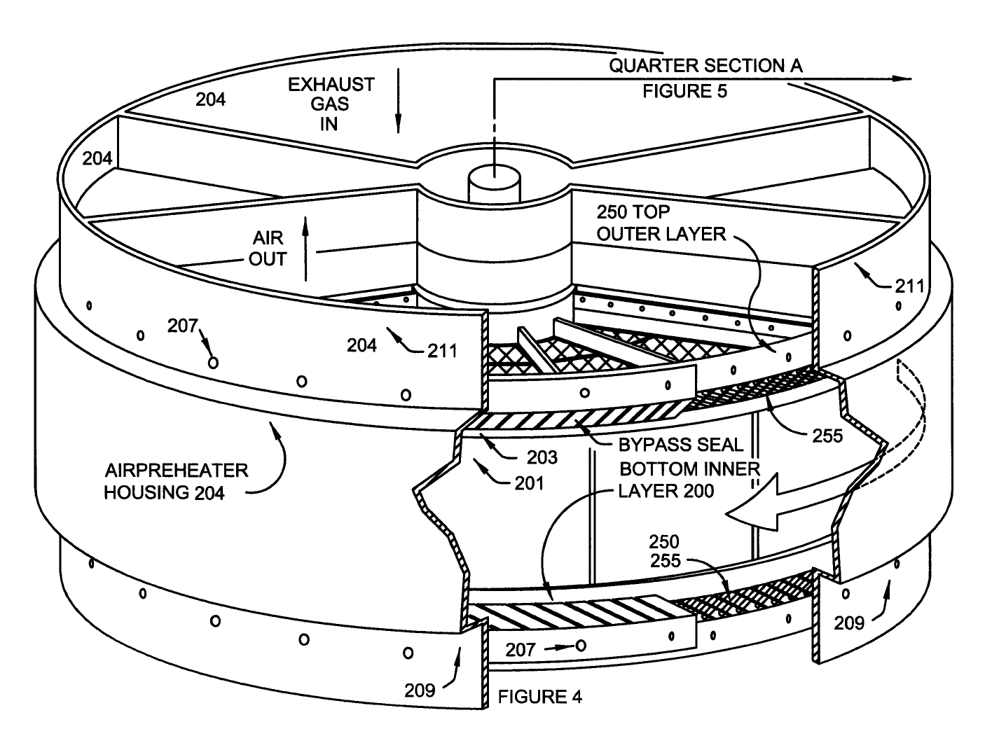

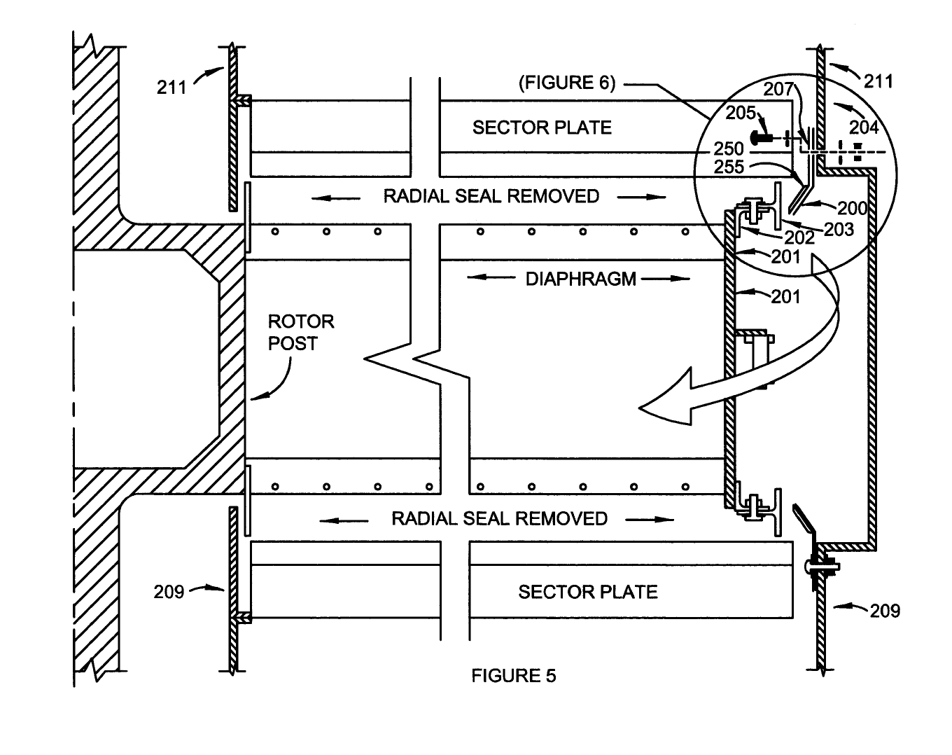

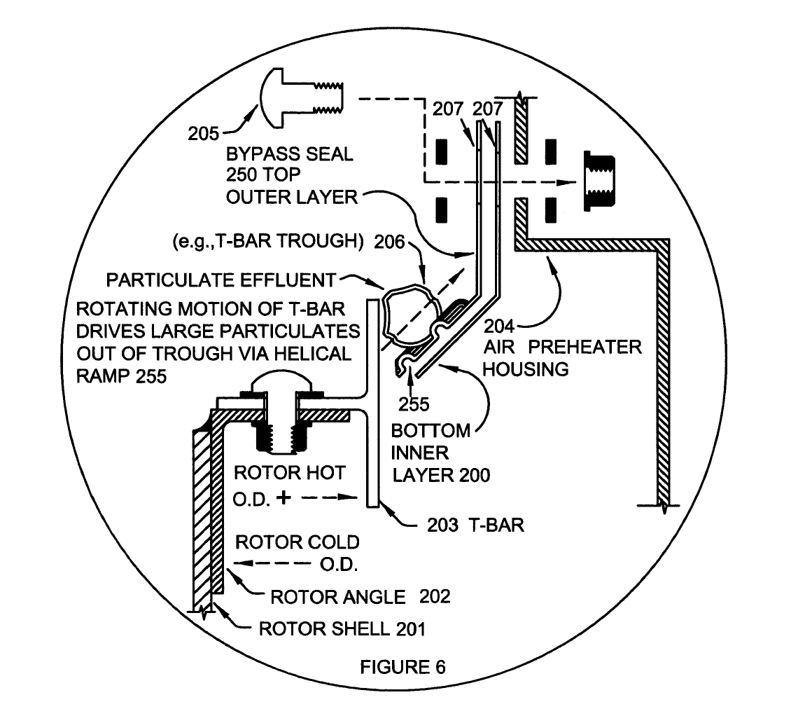

Referring to FIGS. 4 and 5, bypass seal body, e.g., bottom layer 200, top layer 250, attaches to stationary air preheater housing 204 via one or more attachments, e.g., screws 205 (see FIG. 5), pins, glue, epoxy, or the like, at one or more alignment/mounting hole(s) 207. Bypass seal body 200, 250 mounts concentrically about rotor shell 201 at rotor angle 202 at an elevation similar to that of mounted t-bar 203. T-bar creates a trough for contacting ends of, e.g., top outer layer 250 of bypass seal 200, 250. Bypass seal body 200, 250 operatively couples proximal to upper face 209 and lower face 211 of rotor shell 201. In operation, e.g., during rotor turn-down, rotor shell 201 heats and reaches a desired operating temperature. At the desired operating temperature, rotor shell 201 expands and moves t-bar 203 created trough attached to rotor shell outward along an outer diameter of rotor shell 201. As such, t-bar, e.g., created trough maintains interference contact with top outer layer 250 of bypass seal 200, 250.

Advantageously, as rotor shell 201 rotates and flexes, t-bar 203 operation provides a temperature variable, interference contact, e.g., temperature variant trough distance, with outer layer 250 of bypass seal 200, 250. For example, as rotor shell 201 flexes or expands or contracts, t-bar 203 created trough moves inward or outward to change contact point with outer layer 250 of bypass seal body 200, 250 to provide improved sealing operation and changes, e.g., expands or contracts, as a function of temperature. As such, t-bar 203 temperature dependent contact provides an opportunity to create an improved bypass seal life and performance by preventing unnecessary friction contact during a one or more turn-down temperature(s) or ranges thereof.

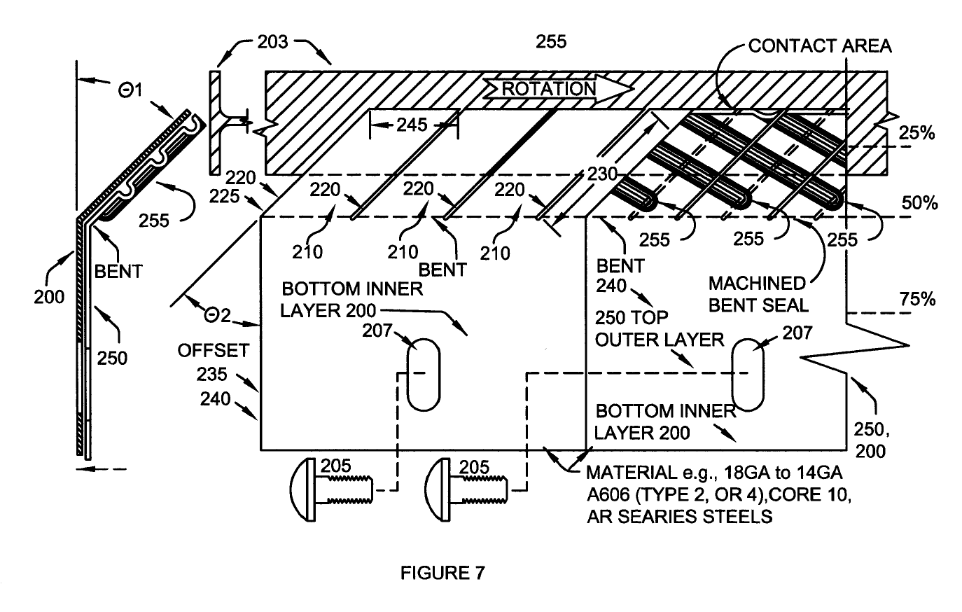

Leafs of bypass seal body 200, 250 length are formed at a substantially acute angle, e.g., contact angle θ₁. In one example, leafs of bypass seal 200, 250 are machined with a range of one-quarter, e.g., ¼, to three-quarters, e.g., ¾'s, from a contact area of shingles of bypass seal, e.g., bottom layer 200, top layer 250. Advantageously, by angling leafs equal to or greater than one-half from the middle point of the bypass seal body, e.g., FIG. 7 bent portion at 50%, provides benefit of increased flexibility. The increased flexibility is due to each leaf having additional “play” area, e.g., motion recovery area, or flapping area to adjust sealing properties, for example, due to bypass seal changing material properties as a function of temperature. Thus, increased leaf flexibility aids in the reduction of excessive contact or friction, e.g., prevents unnecessary or excessive bypass seal 200, 250. Furthermore, with reduced friction, the increased flexibility prevent motor significant amperage swings, e.g., maintains consistent operation and energy efficiency of rotor drives during turn-down of rotor shell 201.

In one example, contact angle θ₁, e.g., substantially acute angle between 25 to 60 degrees leaf angle that references t-bar of outer diameter of rotor shell 201. In one example, the contact angle θ₁ is 35 degrees. The internal realignment guide 225 is determined by the leading edge angle θ₂ and refers to the angled shape of the actual leaf, which attaches to the seal body upstream from the point of contact. As such, the leading edge 220 is not perpendicular, e.g., not orthogonal, with respect to opposing circumferential edges, e.g., in FIG. 7, to an outer diameter of the rotor t-bar cylindrical body. The internal realignment guide 225 tends to realign any seal leafs pulling other seal leafs back into position. For example, a foreign body, e.g., small, medium, or large chunks of effluent, may dislodge one or more leafs that enter t-bar, e.g., t-bar shaped, 203 created trough, for instance, during operation at hot end of rotor shell 201.

In another example, multi-layered, e.g., double layered, with another or adjacent leaf of, e.g., self-same seal, in a tandem position 206, e.g., seal bodies 200, 250 may be connected offset by one or more alignment holes. This benefit staggers slots so that a seal leaf slits of leading edge 220 are always covered to improve sealing properties even when one or more leaves are displaced due to effluent. Furthermore, the improved seal design contains a leaf, for example, leaf 210, having a ratio of functional length 230 to width 245, e.g., bending range between 25% to 75% of the length of the self-same seal(s) 200, 250, which has the benefit of resistance to deformation while maintaining good operational flexibility. In one example, width 245 is 50% that of its length, e.g., functional length 230. The improved seal design configuration can serve as a circumferential seal as well as a bypass seal. In addition, as illustrated in FIG. 7, bypass seal 200, 250 design has leading edge 220 that is not perpendicular to a rotor circumference of rotor shell 201. More specifically, in one variant, bypass seal 200 uses a substantially acute angle approach within a range between 25 and 60 degrees. In one example, e.g., leading edge 220 has a leading edge angle θ₂, of a 45 degree angle, with respect to t-bar 203 created trough that reduces or eliminates one or more catch points between rotor shell 201 and bypass seal 200.

In one variation and as illustrated in FIG. 7, bypass seal 200, 250 is made of individual leaf(s) (leaves) 210 that are machined, e.g., having a leading edge angle θ₂ of an acute degree angle, e.g., 25 degrees, 35 degrees, 45 degree angles, 60 degrees or anywhere in between. Advantageously, by using an acute angle, e.g., 45 degree, sealing dimensionality, seal leaf wear is significantly reduced or even eliminated. In one example, the bypass seal 200, 250 is constructed of material within a range of 18GA to 14GA A606 (Type 2 or 4) Core 10, AR SEARIES STEEL. As such, an improved bypass seal of the present disclosure includes forming with any or all the functionality including: machined angle of 45 degrees seal, increased length 230 shingles, increased width shingles 245, as well as staggered leading edge catch points, e.g., for effluent, during one or more stages of bypass seal life, e.g., break-in, mid-life, and end-of-life, as well as at different temperature ranges or rotor shell velocities throughout bypass seal life.

As illustrated in the above text and figures, a rotary seal system is disclosed for an air circulating system. In one example, a rotor shell 201 has one or more air circulation chambers, e.g., hot, cold. As such, each air circulation needs to maintain a proper seal so that air circulation remains separated during transport of either hot or cold air. In one aspect, the system includes a plurality of stationary, flexible seal bodies 200, 250 arranged in an angled fashion, e.g., contact angle θ₁, leading edge angle θ₂, operatively coupled about opposing circumferential edges 209, 211 of the rotor shell 201 to maintain separation between the one or more air circulation chambers, e.g., hot, cold. In one example, the flexible seal bodies 200, 250 have a substantially 45 degree edge leading edge angle, e.g., leading edge angle θ₂, that contacts and creates a bypass seal 200 on the opposing circumferential edges 209, 211 of the rotor shell 201 so as to maintain air separation between one or more air circulation chambers, e.g., hot and cold. In another example, the flexible seal bodies 200, 250 overlap with one or more adjacent flexible seal bodies 200, 250 so that slits of the one or more adjacent flexible seal bodies 200, 250 maintain coverage independent of and throughout one or more air circulation cycles, e.g., turn-down cycles, of the rotor shell 201. In one variant, the system includes t-bar created troughs coupled proximal to the opposing circumferential edges of the rotor shell 201 to directly contact and maintain an internal alignment of contacting edges of the plurality of stationary, flexible seal bodies 200, 250 to realign any seal leafs 210 dislodged during operation by chunks of effluent.

In one alternative, the flexible seal bodies 200, 250 arranged in an angled fashion includes flexible seal bodies 200, 250 having substantially 45 degrees leading edge angle, e.g., leading edge angle θ₂, along adjacent edges. In yet another example, the flexible seal bodies 200, 250 are arranged in an angled fashion include the flexible seal bodies 200, 250 having leading edge angled sidewalls, e.g., at leading edge angle θ₂, and angled edges at a contact angle, e.g., contact angle θ₁, the leading edge angled sidewalls and angled edges contact the opposing circumferential edges 209, 211 of the rotor shell 201 at a substantially non-orthogonal position. In yet another alternative, the flexible seal bodies 200, 250 are arranged on opposing circumferential edges 209, 211 of the rotor shell 201 including the flexible seal bodies 200, 250 on one opposing circumferential edges maintain air separation between a hot and a cold portion of the air circulating system. In one variant, at least one portion of the flexible seal bodies 200, 250 is arranged in an angled fashion maintain contact with the rotor shell independent of a level of effluent that passes from a first portion of the air chamber separated by one set of the opposing circumferential edges 209, 211 and a second portion of the air chamber separated by another set of the opposing circumferential edge 209, 211.

Turning to FIG. 7, a method 300 is disclosed for manufacturing a sealing structure about a cylindrical structure for a rotor shell 201. In this exemplary embodiment, the method includes forming leafs 210 of a bypass seal body 200, 250 having a length at a substantially acute angle within a range of one-fourth (1 quarter) to three quarters (three-fourths) from a contact area of shingles of the bypass seal body 200, 250 to a rotor body shell, e.g., step 302. In one variant, the method includes forming the leafs of the bypass seal body having a width approximately fifty percent of that of the length of the bypass seal body to provide shingles that contact the rotor body shell whereby flexibility of the leafs 210 provides a motion recovery area to adjust a bypass seal properties as a function of temperature, e.g., step 304.

In one variant of step 306, the method includes forming shingles of the leafs 210 of the bypass seal body 200, 250 of a width that is approximately fifty percent less than that of the length of the leaf to provide a motion recovery area and an internal alignment guide relative to the rotor shell body. In one alternative of step 306, the method includes forming shingles of the leafs 210 of the bypass seal body 200, 250 that provide an internal realignment guide during break-in, mid-life, and end-of-life of the leafs 210. In yet another variant of step 306, the method includes forming shingles of the leafs of the bypass seal body 200, 250 that provide an internal realignment guide in accordance with a temperature range or rotor shell velocity based on stage of bypass seal life including break-in, mid-life, and end-of life.

In one variant, the method includes forming one or more attachment points including staggered slots of the bypass seal body 200, 250 so that one or more adjacent leafs 210 are capable of being joined in a tandem position, offset, or multi-layered to improve sealing properties during displacement of one or more leaves 210 when effluent dislodges one or more of the leafs 210 or during one or more turn-down temperature ranges at a hot end of the rotor shell (step 306). In yet another variant, the method includes forming shingles at contact ends of the leafs that intersect with a t-bar 203 created trough proximal to an outer circumference of the rotor shell 201 to provide benefit of increased leaf flexibility to provide a reduction of excessive contact or friction due to bypass seal changing material properties as a function of temperature (step 308).

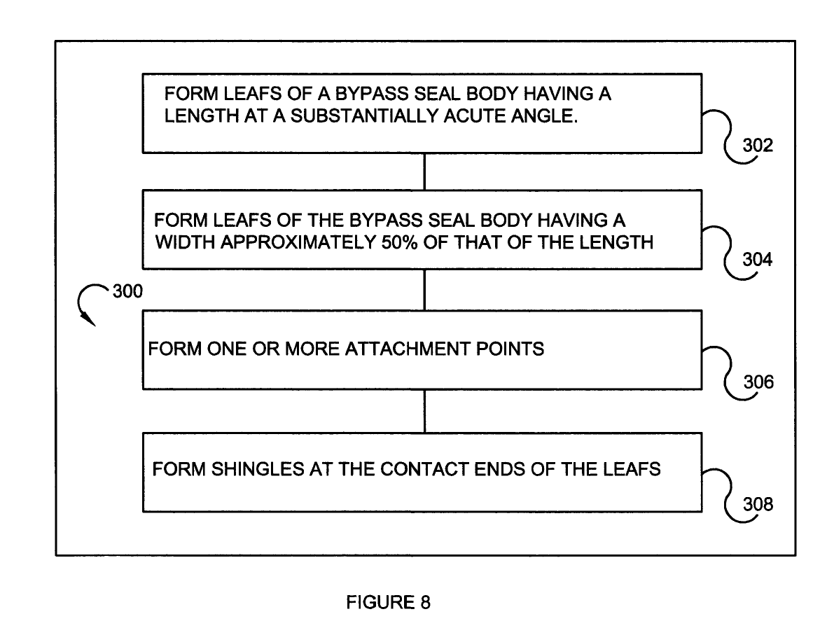

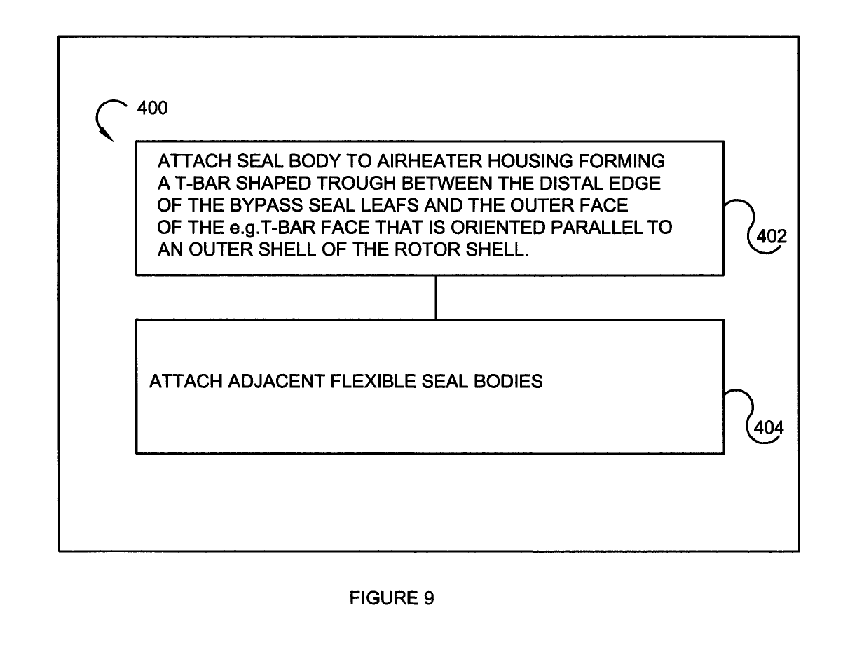

Turning now to FIG. 8, a method 400 is disclosed for installing a bypass seal 200, 250 for a rotor shell 201. In this exemplary embodiment, the method includes: attaching a t-bar shaped trough to the rotor shell 201, the t-bar shaped trough oriented parallel to an outer shell of the rotor shell 201, e.g., step 402. In one variant, the method may include the step of attaching adjacent flexible seal bodies 200, 250 on opposing circumferential edges of an air preheater housing so that a bypass seal top outer layer 250 of the adjacent seal bodies contacts the t-bar shaped trough on a helical ramp 255 having a substantially acute angle between 25 to 75 degrees, whereby the bypass seal top outer layer 250 maintains contact with the t-bar shaped trough independent of temperature operation of the rotor shell, e.g., step 404. In one variant of step 402, the method includes attaching adjacent flexible seal bodies 200, 250 includes staggering attachment points so that slits of the adjacent flexible seal bodies 200, 250 maintain seal body coverage when one or more leafs 210, are dislodged. Advantageously, in this method, no leading edge, e.g., leading edge 220, of the adjacent flexible seal bodies 200, 250 near perpendicular to a circumference of the rotor shell 201.

I claim:

1. A rotary seal system for an air circulating system including a rotor shell having one or more air circulation chambers, the system comprising:
a plurality of stationary, flexible seal bodies arranged in an angled fashion operatively coupled about opposing circumferential edges of the rotor shell to maintain separation between the one or more air circulation chambers.

2. The system of claim 1, wherein the flexible seal bodies include a substantially 45 degree leading edge angle that contacts and creates a bypass seal on the opposing circumferential edges of the rotor shell to maintain air separation between one or more air circulation chambers.

3. The system of claim 1, wherein the flexible seal bodies overlap with one or more adjacent flexible seal bodies so that slits of the one or more adjacent flexible seal bodies maintain coverage independent of and throughout one or more air circulation cycles of the rotor shell.

4. The system of claim 1, further comprising a helical ramp that contacts the rotor shell at a substantially 45 degree contact angle opposing directed to that of the flexible seal bodies;
and wherein the flexible seal bodies arranged in an angled fashion includes flexible seal bodies having substantially 45 degrees leading edge angle along adjacent edges.

5. The system of claim 1, wherein the flexible seal bodies arranged in an angled fashion include the flexible seal bodies having leading edge angled sidewalls and angled edges at a contact angle, a leading edge angle contacts the opposing circumferential edges of the rotor shell at a substantially non-orthogonal position.

6. The system of claim 1, wherein the flexible seal bodies on opposing circumferential edges of the rotor shell including the flexible seal bodies on one opposing circumferential edges maintain air separation between a hot and a cold portion of the air circulating system.

7. The system of claim 1, wherein at least one portion of the flexible seal bodies arranged in an angled fashion maintain contact with the rotor shell independent of a level of effluent that passes from a first portion of the air chamber separated by one set of the opposing circumferential edges and a second portion of the air chamber separated by another set of the opposing circumferential edges.

8. The system of claim 1, comprising t-bar created troughs coupled proximal to the opposing circumferential edges of the rotor shell to directly contact and maintain an internal alignment of contacting edges of the plurality of stationary, flexible seal bodies to realign any seal leafs dislodged during operation by chunks of effluent.

9. The system of claim 1, wherein the plurality of stationary, flexible seal bodies include leafs machined within a range of approximately one-quarter to three-quarters from a contact area about the opposing circumferential edges of the rotor shell to provide a motion recovery area or flapping area to adjust sealing properties due to bypass seal material properties changing as a function of temperature.

10. A method for manufacturing a sealing structure about a cylindrical structure for a rotor shell, the method comprising:
forming leafs of a bypass seal body having a length at a substantially acute angle within a range of one-quarter to three quarters from a contact area of shingles of the bypass seal body to a rotor body shell.

11. The method of claim 10, comprising forming the leafs of the bypass seal body having a width approximately fifty percent of that of the length of the bypass seal body to provide shingles that contact the rotor body shell whereby flexibility of the leafs provides a motion recovery area to adjust a bypass seal properties as a function of temperature.

12. The method of claim 10, comprising forming shingles of the leafs of the bypass seal body of a width that is approximately fifty percent less than that of the length of the leaf to provide a motion recovery area and an internal alignment guide relative to the rotor shell body.

13. The method of claim 10, comprising forming shingles of the leafs of the bypass seal body that provide an internal realignment guide during break-in, mid-life, and end-of-life of the leafs; wherein the internal realignment guide includes a helical ramp positioned acutely with respect to an edge of the rotor shell.

14. The method of claim 10, comprising forming shingles of the leafs of the bypass seal body that provide an internal realignment guide in accordance with a temperature range or rotor shell velocity based on stage of bypass seal life including break-in, mid-life, and end-of life; wherein the internal realignment guide includes a helical ramp positioned acutely with respect to an edge of the rotor shell.

15. The method of claim 10, comprising forming one or more attachment points including staggered slots of the bypass seal body so that one or more adjacent leafs are capable of being joined in a tandem position, offset, or multi-layered to improve sealing properties during displacement of one or more leaves when effluent dislodges one or more of the leafs or during one or more turn-down temperature ranges at a hot end of the rotor shell.

16. The method of claim 10, forming shingles at contact ends of the leafs that intersect with a t-bar created trough proximal to an outer circumference of the rotor shell to provide benefit of increased leaf flexibility to provide a reduction of excessive contact or friction due to the bypass seal body changing material properties as a function of temperature.

17. A method for installing a bypass seal for a rotor shell, the method comprising:
attaching a t-bar shaped trough to the rotor shell, the t-bar shaped trough oriented parallel to an outer shell of the rotor shell; and
attaching adjacent flexible seal bodies on opposing circumferential edges of an air preheater housing so that a bypass seal top outer layer of the adjacent seal bodies contacts the t-bar shaped trough on a helical ramp having a substantially acute angle between 25 to 75 degrees with respect to the outer shell of the rotor shell, whereby the bypass seal top outer layer maintains contact with the t-bar shaped trough independent of a temperature of operation of the rotor shell.

18. The method of claim 17, wherein attaching adjacent flexible seal bodies includes staggering attachment points of the adjacent flexible seal bodies so that slits of the adjacent flexible seal bodies maintain seal body coverage when one or more leafs are dislodged.

19. The method of claim 17, wherein no leading edge of the adjacent flexible seal bodies is near perpendicular to a circumference of the rotor shell.
